(19) United States
(12) Patent Application Publication
(10) Pub. No.: US 2011/0301840 A1
(43) Pub. Date: Dec. 8, 2011

(54) NAVIGATION SYSTEM WITH SHARED TRANSPORTATION AND METHOD OF OPERATION THEREOF

(75) Inventor: Zhou Wang, Shanghai (CN)

(73) Assignee: TELENAV, INC., Sunnyvale, CA (US)

(21) Appl. No.: 12/796,479

(22) Filed: Jun. 8, 2010

(51) Int. Cl. G01C 21/00

(52) U.S. Cl. 701/202; 701/200

(57) ABSTRACT

A method of operation of a navigation system includes: receiving a transport request for transporting a transport entity; identifying one or more transportation modes based on the transport request for locating a transportation provider; generating a navigation instruction based on the transport request and the transportation modes, the navigation instruction for displaying on a device and for transporting the transport entity; and updating the navigation instruction for transporting the transport entity with a further transportation provider.

### TECHNICAL FIELD

The present invention relates generally to a navigation system, and more particularly to a system for travelers.

### BACKGROUND ART

The social and economic health of a society depends on mobility of people, merchandise, or information, from one geographic location to another geographic location. In the modern world, the mobility of the information can typically be transferred between different geographic locations using electronic based technology solutions such as Internet exchanges, or voice communications.

A majority of the mobility involves physical transportation of the people, the merchandise, or a combination thereof and currently cannot be accomplished by the electronic based technology solutions. The physical transportation can include delivery by land, air, or sea using personal, private, public, or commercial transportation.

Navigation devices or products, such as a global positioning service (GPS), maps, or directions, can however provide travel assistance to ensure delivery or movement between multiple geographic locations.

Since the navigation devices or the navigation products simply provide assistance with travel, mobility of people or merchandise can be constrained and inefficient. There is a growing need to minimize costs, transportation delays, environmental carbon footprint impacts, or transportation and travel stresses.

Thus, a need still remains for a navigation system with an improved transportation mechanism to provide benefits of minimized costs and to maximize efficiency while improving reliability, safety, or handling of the people or merchandise. In view of the ever increasing social and economic transportation needs of the world, it is increasingly critical that answers be found to these problems.

In view of growing consumer expectations, an improved system for movement of people or goods in a timely manner are highly sought after it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: receiving a transport request for transporting a transport entity; identifying one or more transportation modes based on the transport request for locating a transportation provider; generating a navigation instruction based on the transport request and the transportation modes, the navigation instruction for displaying on a device and for transporting the transport entity; and updating the navigation instruction for transporting the transport entity with a further transportation provider.

The present invention provides a navigation system, including: a user interface for receiving a transport request for transporting a transport entity; a location unit, coupled to the user interface, for identifying one or more transportation modes based on the transport request for locating a transportation provider; a route planning module, coupled to the location unit, for generating a navigation instruction based on the transport request and the transportation modes, the navigation instruction for displaying on a device and for transporting the transport entity; and a control unit, coupled to the route planning module, for updating the navigation instruction for transporting the transport entity with a further transportation provider.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with a transportation dispatch processing mechanism in a first embodiment of the present invention.

FIG. 2 is an example of a display interface of the first device.

FIG. 3 is another example of the display interface of the first device.

FIG. 4 is an exemplary block diagram of the first device.

FIG. 5 is an exemplary block diagram of a navigation system with a transportation dispatch processing mechanism in a second embodiment of the present invention.

FIG. 6 is a navigation system with a transportation dispatch processing mechanism in a third embodiment of the present invention.

FIG. 7 is a flow chart of a method of operation of a navigation system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a micro electro mechanical system (MEMS), passive devices, or a combination thereof.

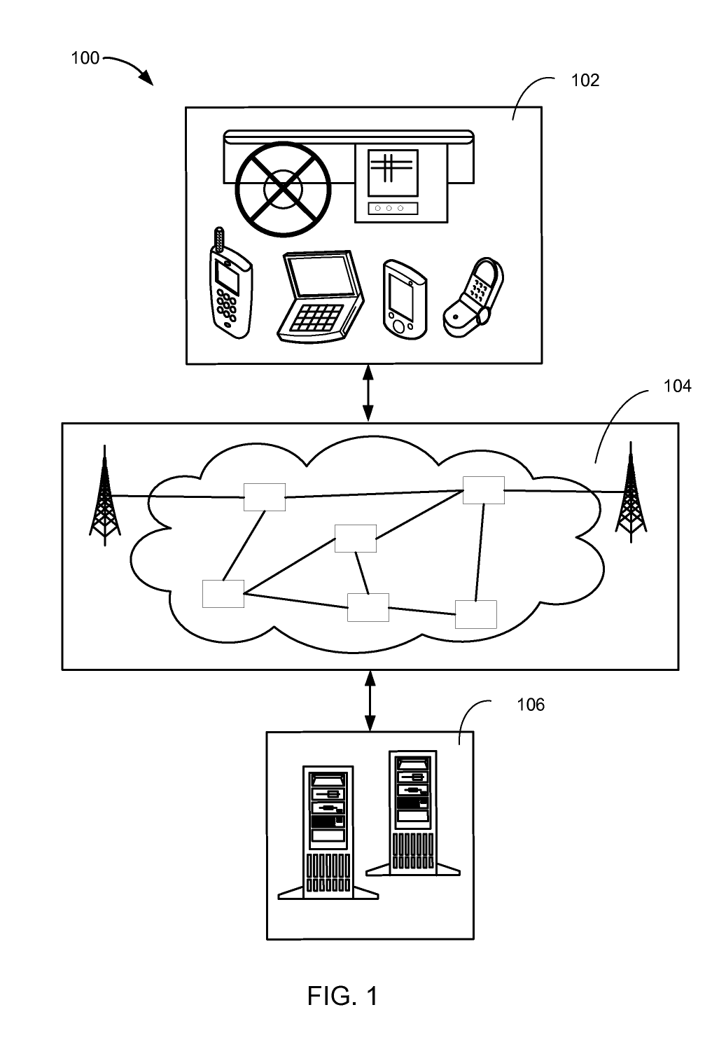

Referring now to FIG. 1, therein is shown a navigation system 100 with a transportation dispatch processing mechanism in a first embodiment of the present invention. The navigation system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the navigation system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In a further example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet further example, the second device 106 can be a particularized machine, such as a portable computing device, a thin client, a notebook, a netbook, a smartphone, personal digital assistant, or a cellular phone, and as specific examples, an Apple iPhone™, Palm Centro™, or Moto Q Global™.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

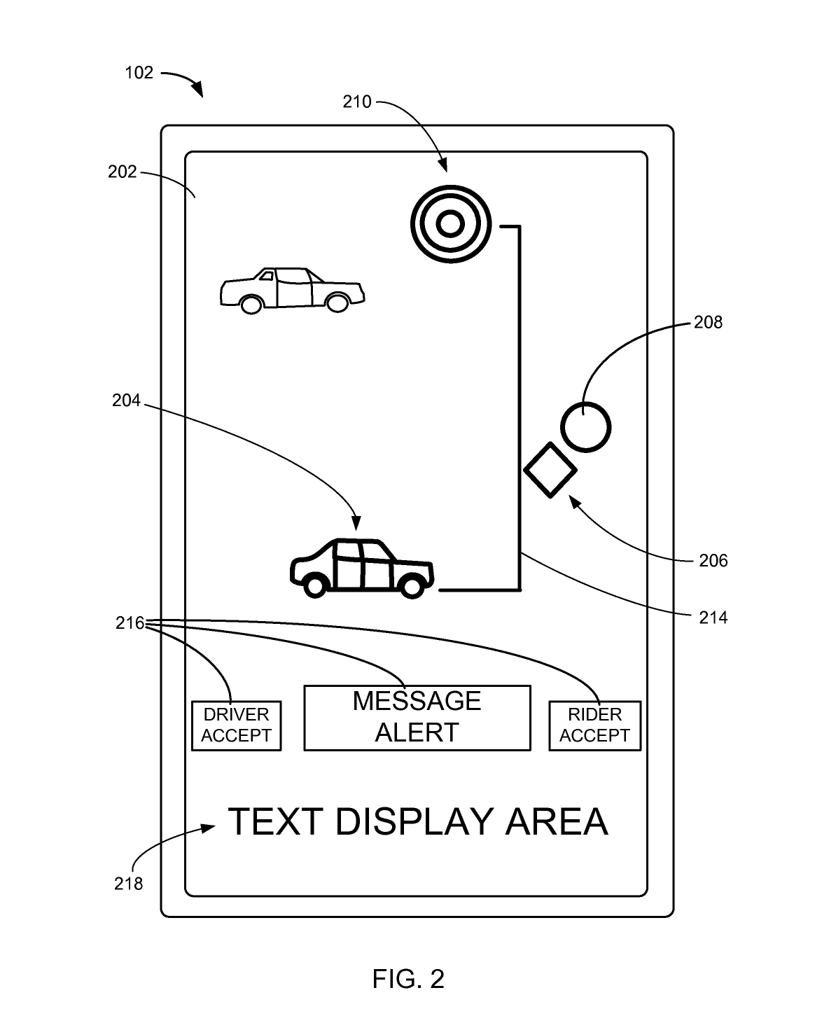

Referring now to FIG. 2, therein is shown an example of a display interface 202 of the first device 102. The display interface 202 can be used to show relative geographical locations of transportation providers 204, a transfer point 206, a transport entity 208, a destination point 210, and a relative geographical route 214. The transportation providers 204 provide one or more type of transportation such as a car, a bus, a train, an aircraft, a subway, a motorcycle, a helicopter, a water vessel, or any method of transportation resulting in movement of goods, material, or personnel.

The transportation providers 204 can be used to move the transport entity 208 such as a passenger, cargo, or merchandise. The transportation providers 204 can include a mixture of different categories or types of mobile transportation apparatus. The mixture of different categories or types of mobile transportation apparatus can include a car, a bus, a train, an aircraft, a subway, a motorcycle, a helicopter, a water vessel, or any method of transportation resulting in movement of goods, material, or personnel.

For purposes of illustration, two of the transportation providers 204 are shown. There can be any number of the transportation providers 204 shown on the display interface 202 and each of the transportation providers 204 can be visually distinguishable from one another. For example, different shades, highlights, colors, text, or symbols can be used to distinguish between each of the transportation providers 204.

The transfer point 206 can indicate a geographic location or region for pick-up or drop-off of the transport entity 208. The first device 102 can be used to request transportation or receive a request for transportation for the transport entity 208.

The destination point 210 can be a geographical location or region where the transport entity 208 can be separated from the transportation providers 204. The relative geographical route 214 can be used to indicate travel information. The travel information can display relative travel movements, detailed navigating directions, or a geographical overview of an entire trip sized to fit on the display interface 202.

A visual graphic area 216 of the display interface 202 can be customized to show or indicate optional information available to the user. For example, the visual graphic area 216 can be used to indicate events, such as a message alert, a driver acknowledgement to pick up the transport entity 208, or an acknowledgement of acceptance for delivery or transportation service. The visual graphic area 216 can also be programmed to display identification information of the transportation providers 204, the transport entity 208, a geographical location, or user defined information.

Graphical symbols or representations shown on the display interface 202 can be changed. For example, the graphical symbols or representations of the transportation providers 204 could have been shown as a rectangle, a push-pin, or a flag on the display interface 202.

A text display area 218 of the display interface 202 can be used to display a question, a reply to a question, an estimate time of arrival to the transfer point 206 or the destination point 210, a rider request for transportation service, a rider request for suspension of service, an alternate route option, a cancellation request, or any navigation related information such as destinations, directions, routes, locations, traffic delays, or detours.

An operator, such as a driver, a pilot, or a commander of the transportation providers 204 can optionally have a mobile device (not shown) such as another of the first device 102. The mobile device can include a display interface such as the display interface 202 showing information identical to information shown on the first device 102 or other information specific to the needs and interest of the operator.

For example, the mobile device can optionally include additional information such as geographic locations of the transportation providers 204 within a pre-defined radius around the operator. Each of the transportation providers 204 can include another mobile device such as the first device 102 or another device functionally compatible with the first device 102 capable of coupling or exchanging information with the first device 102.

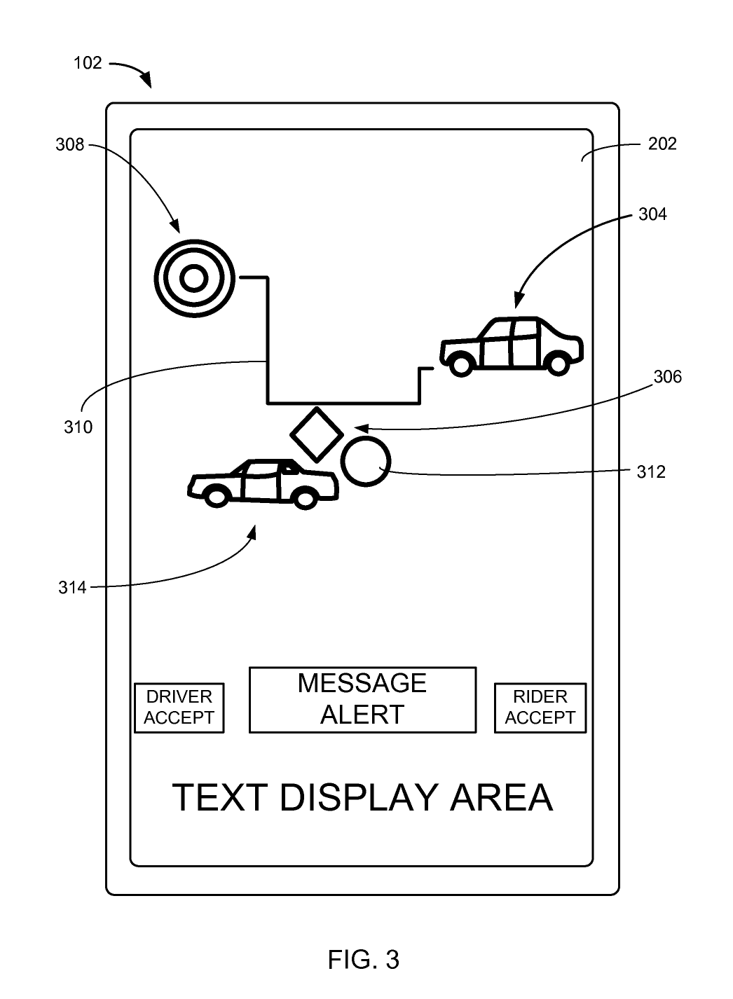

Referring now to FIG. 3, therein is shown another example of the display interface 202 of the first device 102. Transportation providers 304 can have access to a plurality of the first device 102. Geographical or relative locations of the transportation providers 304, a transfer point 306, a destination point 308, and a designated geographical route 310 can be shown on the display interface 202.

The designated geographical route 310 shows a direction or a path to be travelled by one of the transportation providers 304. The transfer point 306 shown on the display interface 202 represents a navigational location where the one of the transportation providers 304 is to arrive at before proceeding to the destination point 308. The transfer point 306 can be used by the transportation providers 304 to pick-up or drop off a transport entity 312.

The transport entity 312 can be dropped-off by second transportation providers 314 and picked-up by the transportation providers 304 on route to the destination point 308. The transportation providers 304 can have a plurality of the transport entity 312 that can be dropped-off at the transfer point 306. The plurality of the transport entity 312 can be picked-up at the transfer point 306 by the second transportation providers 314 on a route travelling away from the destination point 308.

There is no limit to the number of different geographic locations, transfer points, directions, distances, or vehicles included with a geographical route. The transportation providers 304 can include a mixture of different categories or types of mobile transportation apparatus. The mixture of different categories or types of mobile transportation apparatus can include a car, a bus, a train, an aircraft, a subway, a motorcycle, a helicopter, a water vessel, or any method of transportation resulting in movement of goods, material, or personnel.

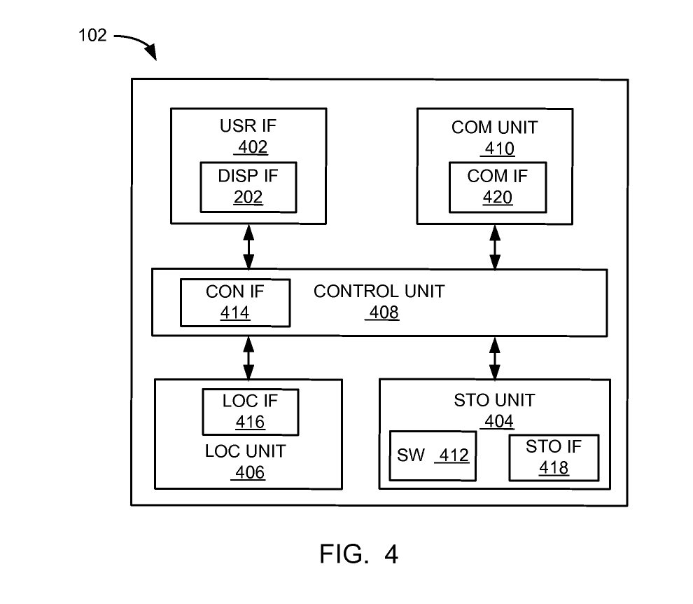

Referring now to FIG. 4, therein is shown an exemplary block diagram of the first device 102. The first device 102 can include a user interface 402, a storage unit 404, a location unit 406, a control unit 408, and a communication unit 410.

The user interface 402 allows a user (not shown) to interface and interact with the first device 102. The user interface 402 can include an input device and an output device. Examples of the input device of the user interface 402 can include a keypad, a touchpad, soft-keys, a keyboard, a microphone, or any combination thereof to provide data and communication inputs. Examples of the output device of the user interface 402 can include the display interface 202. The display interface 202 can include a display, a projector, a video screen, a speaker, or any combination thereof.

The control unit 408 can execute a software 412 to provide the intelligence of the navigation system 100. The control unit 408 can operate the user interface 402 to display information generated by the navigation system 100. The control unit 408 can also execute the software 412 for the other functions of the navigation system 100, including receiving location information from the location unit 406. The control unit 408 can further execute the software 412 for interaction with the communication path 104 of FIG. 1 via the communication unit 410.

The control unit 408 can be implemented in a number of different manners. For example, the control unit 408 can be a processor, an embedded processor, a microprocessor, a hardware control logic, a hardware finite state machine (FSM), a digital signal processor (DSP), or a combination thereof.

The control unit 408 can include a controller interface 414. The controller interface 414 can be used for communication between the control unit 408 and other functional units in the first device 102. The controller interface 414 can also be used for communication that is external to the first device 102.

The controller interface 414 can receive information from the other functional units or from external sources, or can transmit information to the other functional units or to external destinations. The external sources and the external destinations refer to sources and destinations external to the first device 102.

The controller interface 414 can be implemented in different ways and can include different implementations depending on which functional units or external units are being interfaced with the controller interface 414. For example, the controller interface 414 can be implemented with a pressure sensor, an inertial sensor, a microelectromechanical system (MEMS), optical circuitry, waveguides, wireless circuitry, wireline circuitry, or a combination thereof.

The location unit 406 can generate location information, current heading, and current speed of the first device 102, as examples. The location unit 406 can be implemented in many ways. For example, the location unit 406 can function as at least a part of a global positioning system (GPS), an inertial navigation system, a cellular-tower location system, a pressure location system, or any combination thereof.

The location unit 406 can include a location interface 416. The location interface 416 can be used for communication between the location unit 406 and other functional units in the first device 102. The location interface 416 can also be used for communication that is external to the first device 102.

The location interface 416 can receive information from the other functional units or from external sources, or can transmit information to the other functional units or to external destinations. The external sources and the external destinations refer to sources and destinations external to the first device 102.

The location interface 416 can include different implementations depending on which functional units or external units are being interfaced with the location unit 406. The location interface 416 can be implemented with technologies and techniques similar to the implementation of the controller interface 414.

The storage unit 404 can store the software 412. The storage unit 404 can also store the relevant information, such as advertisements, points of interest (POI), navigation routing entries, or any combination thereof.

The storage unit 404 can be a volatile memory, a nonvolatile memory, an internal memory, an external memory, or a combination thereof. For example, the storage unit 404 can be a nonvolatile storage such as non-volatile random access memory (NVRAM), Flash memory, disk storage, or a volatile storage such as static random access memory (SRAM).

The storage unit 404 can include a storage interface 418. The storage interface 418 can be used for communication between the location unit 406 and other functional units in the first device 102. The storage interface 418 can also be used for communication that is external to the first device 102.

The storage interface 418 can receive information from the other functional units or from external sources, or can transmit information to the other functional units or to external destinations. The external sources and the external destinations refer to sources and destinations external to the first device 102.

The storage interface 418 can include different implementations depending on which functional units or external units are being interfaced with the storage unit 404. The storage interface 418 can be implemented with technologies and techniques similar to the implementation of the controller interface 414.

The communication unit 410 can enable external communication to and from the first device 102. For example, the communication unit 410 can permit the first device 102 to communicate with the second device 106 of FIG. 1, an attachment, such as a peripheral device or a computer desktop, and the communication path 104.

The communication unit 410 can also function as a communication hub allowing the first device 102 to function as part of the communication path 104 and not limited to be an end point or terminal unit to the communication path 104. The communication unit 410 can include active and passive components, such as microelectronics or an antenna, for interaction with the communication path 104.

The communication unit 410 can include a communication interface 420. The communication interface 420 can be used for communication between the communication unit 410 and other functional units in the first device 102. The communication interface 420 can receive information from the other functional units or can transmit information to the other functional units.

The communication interface 420 can include different implementations depending on which functional units are being interfaced with the communication unit 410. The communication interface 420 can be implemented with technologies and techniques similar to the implementation of the controller interface 414.

For illustrative purposes, the navigation system 100 is shown with the partition having the user interface 402, the storage unit 404, the location unit 406, the control unit 408, and the communication unit 410 although it is understood that the navigation system 100 can have a different partition. For example, the software 412 can be partitioned differently such that some or all of its function can be in the control unit 408, the location unit 406, and the communication unit 410. Also, the first device 102 can include other functional units not shown in FIG. 4 for clarity.

The functional units in the first device 102 can work individually and independently of the other functional units. The first device 102 can work individually and independently from the second device 106 and the communication path 104.

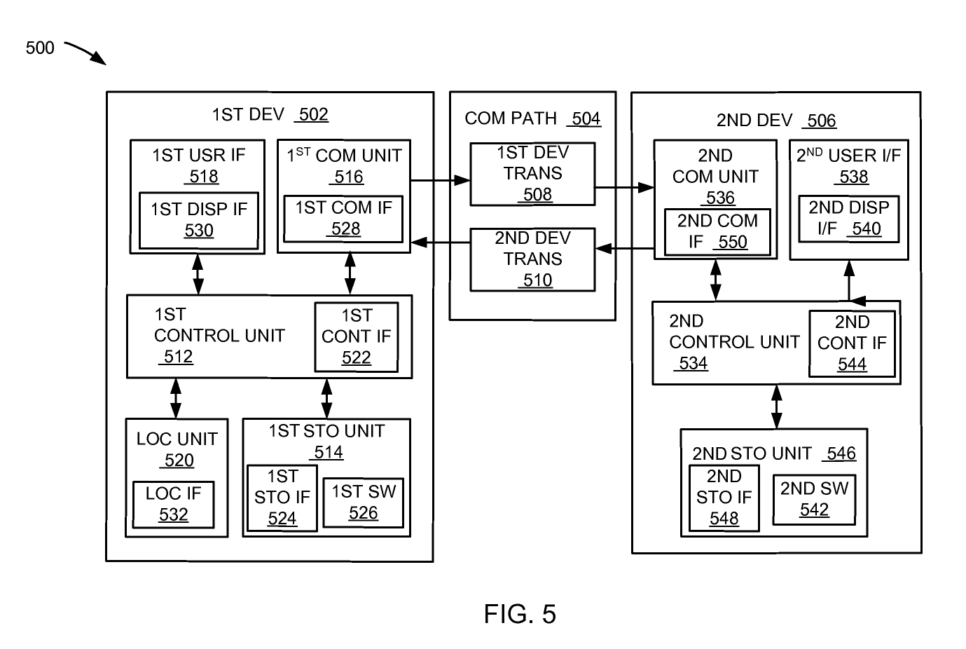

Referring now to FIG. 5, therein is shown an exemplary block diagram of a navigation system 500 with a transportation dispatch processing mechanism in a second embodiment of the present invention. The navigation system 500 can include a first device 502, a communication path 504, and a second device 506.

The first device 502 can communicate with the second device 506 over the communication path 504. For example, the first device 502, the communication path 504, and the second device 506 can be the first device 102 of FIG. 1, the communication path 104 of FIG. 1, and the second device 106 of FIG. 1, respectively. The screen shot shown on the display interface 202 described in FIG. 2 can represent the screen shot for the navigation system 500.

The first device 502 can send information in a first device transmission 508 over the communication path 504 to the second device 506. The second device 506 can send information in a second device transmission 510 over the communication path 504 to the first device 502.

For illustrative purposes, the navigation system 500 is shown with the first device 502 as a client device, although it is understood that the navigation system 500 can have the first device 502 as a different type of device. For example, the first device 502 can be a server.

Also for illustrative purposes, the navigation system 500 is shown with the second device 506 as a server, although it is understood that the navigation system 500 can have the second device 506 as a different type of device. For example, the second device 506 can be a client device.

For brevity of description in this embodiment of the present invention, the first device 502 will be described as a client device and the second device 506 will be described as a server device. The present invention is not limited to this selection for the type of devices. The selection is an example of the present invention.

The first device 502 can include a first control unit 512, a first storage unit 514, a first communication unit 516, a first user interface 518, and a location unit 520. The first device 502 can be similarly described by the first device 102.

The first control unit 512 can include a first control interface 522. The first control unit 512 and the first control interface 522 can be similarly described as the control unit 408 of FIG. 4 and the controller interface 414 of FIG. 4, respectively.

The first storage unit 514 can include a first storage interface 524. The first storage unit 514 and the first storage interface 524 can be similarly described as the storage unit 404 of FIG. 4 and the storage interface 418 of FIG. 4, respectively. A first software 526 can be stored in the first storage unit 514.

The first communication unit 516 can include a first communication interface 528. The first communication unit 516 and the first communication interface 528 can be similarly described as the communication unit 410 of FIG. 4 and the communication interface 420 of FIG. 4, respectively.

The first user interface 518 can include a first display interface 530. The first user interface 518 and the first display interface 530 can be similarly described as the user interface 402 of FIG. 4 and the display interface 202 of FIG. 4, respectively.

The location unit 520 can include a location interface 532. The location unit 520 and the location interface 532 can be similarly described as the location unit 406 of FIG. 4 and the location interface 416 of FIG. 4, respectively.

The performance, architectures, and type of technologies can also differ between the first device 102 and the first device 502. For example, the first device 102 can function as a single device embodiment of the present invention and can have a higher performance than the first device 502. The first device 502 can be similarly optimized for a multiple device embodiment of the present invention.

For example, the first device 102 can have a higher performance with increased processing power in the control unit 408 compared to the first control unit 512. The storage unit 404 can provide higher storage capacity and access time compared to the first storage unit 514.

Also for example, the first device 502 can be optimized to provide increased communication performance in the first communication unit 516 compared to the communication unit 410. The first storage unit 514 can be sized smaller compared to the storage unit 404. The first software 526 can be smaller than the software 412 of FIG. 4.

The second device 506 can be optimized for implementing the present invention in a multiple device embodiment with the first device 502. The second device 506 can provide the additional or higher performance processing power compared to the first device 502. The second device 506 can include a second control unit 534, a second communication unit 536, and a second user interface 538.

The second user interface 538 allows a user (not shown) to interface and interact with the second device 506. The second user interface 538 can include an input device and an output device. Examples of the input device of the second user interface 538 can include a keypad, a touchpad, soft-keys, a keyboard, a microphone, or any combination thereof to provide data and communication inputs. Examples of the output device of the second user interface 538 can include a second display interface 540. The second display interface 540 can include a display, a projector, a video screen, a speaker, or any combination thereof.

The second control unit 534 can execute a second software 542 to provide the intelligence of the second device 106 of the navigation system 500. The second software 542 can operate in conjunction with the first software 526. The second control unit 534 can provide additional performance compared to the first control unit 512 or the control unit 408.

The second control unit 534 can operate the second user interface 538 to display information. The second control unit 534 can also execute the second software 542 for the other functions of the navigation system 500, including operating the second communication unit 536 to communicate with the first device 502 over the communication path 504.

The second control unit 534 can be implemented in a number of different manners. For example, the second control unit 534 can be a processor, an embedded processor, a microprocessor, a hardware control logic, a hardware finite state machine (FSM), a digital signal processor (DSP), or a combination thereof.

The second control unit 534 can include a second controller interface 544. The second controller interface 544 can be used for communication between the second control unit 534 and other functional units in the second device 506. The second controller interface 544 can also be used for communication that is external to the second device 506.

The second controller interface 544 can receive information from the other functional units or from external sources, or can transmit information to the other functional units or to external destinations. The external sources and the external destinations refer to sources and destinations external to the second device 506.

The second controller interface 544 can be implemented in different ways and can include different implementations depending on which functional units or external units are being interfaced with the second controller interface 544. For example, the second controller interface 544 can be implemented with a pressure sensor, an inertial sensor, a microelectromechanical system (MEMS), optical circuitry, waveguides, wireless circuitry, wireline circuitry, or a combination thereof.

A second storage unit 546 can store the second software 542. The second storage unit 546 can also store the relevant information, such as advertisements, points of interest (POI), navigation routing entries, or any combination thereof. The second storage unit 546 can be sized to provide the additional storage capacity to supplement the first storage unit 514.

For illustrative purposes, the second storage unit 546 is shown as a single element, although it is understood that the second storage unit 546 can be a distribution of storage elements. Also for illustrative purposes, the navigation system 500 is shown with the second storage unit 546 as a single hierarchy storage system, although it is understood that the navigation system 500 can have the second storage unit 546 in a different configuration. For example, the second storage unit 546 can be formed with different storage technologies forming a memory hierarchal system including different levels of caching, main memory, rotating media, or off-line storage.

The second storage unit 546 can be a volatile memory, a nonvolatile memory, an internal memory, an external memory, or a combination thereof. For example, the second storage unit 546 can be a nonvolatile storage such as non-volatile random access memory (NVRAM), Flash memory, disk storage, or a volatile storage such as static random access memory (SRAM).

The second storage unit 546 can include a second storage interface 548. The second storage interface 548 can be used for communication between the location unit 406 and other functional units in the second device 506. The second storage interface 548 can also be used for communication that is external to the second device 506.

The second storage interface 548 can receive information from the other functional units or from external sources, or can transmit information to the other functional units or to external destinations. The external sources and the external destinations refer to sources and destinations external to the second device 506.

The second storage interface 548 can include different implementations depending on which functional units or external units are being interfaced with the second storage unit 546. The second storage interface 548 can be implemented with technologies and techniques similar to the implementation of the second controller interface 544.

The second communication unit 536 can enable external communication to and from the second device 506. For example, the second communication unit 536 can permit the second device 506 to communicate with the first device 502 over the communication path 504.

The second communication unit 536 can also function as a communication hub allowing the second device 506 to function as part of the communication path 504 and not limited to be an end point or terminal unit to the communication path 504. The second communication unit 536 can include active and passive components, such as microelectronics or an antenna, for interaction with the communication path 504.

The second communication unit 536 can include a second communication interface 550. The second communication interface 550 can be used for communication between the second communication unit 536 and other functional units in the second device 506. The second communication interface 550 can receive information from the other functional units or can transmit information to the other functional units.

The second communication interface 550 can include different implementations depending on which functional units are being interfaced with the second communication unit 536. The second communication interface 550 can be implemented with technologies and techniques similar to the implementation of the second controller interface 544.

The first communication unit 516 can couple with the communication path 504 to send information to the second device 506 in the first device transmission 508. The second device 506 can receive information in the second communication unit 536 from the first device transmission 508 of the communication path 504.

The second communication unit 536 can couple with the communication path 504 to send information to the first device 502 in the second device transmission 510. The first device 502 can receive information in the first communication unit 516 from the second device transmission 510 of the communication path 504. The navigation system 500 can be executed by the first control unit 512, the second control unit 534, or a combination thereof.

For illustrative purposes, the second device 106 is shown with the partition having the second user interface 538, the second storage unit 546, the second control unit 534, and the second communication unit 536, although it is understood that the second device 106 can have a different partition. For example, the second software 542 can be partitioned differently such that some or all of its function can be in the second control unit 534 and the second communication unit 536. Also, the second device 506 can include other functional units not shown in FIG. 5 for clarity.

The functional units in the first device 502 can work individually and independently of the other functional units. The first device 502 can work individually and independently from the second device 506 and the communication path 504.

The functional units in the second device 506 can work individually and independently of the other functional units. The second device 506 can work individually and independently from the first device 502 and the communication path 504.

For illustrative purposes, the navigation system 500 is described by operation of the first device 502 and the second device 506. It is understood that the first device 502 and the second device 506 can operate any of the modules and functions of the navigation system 500. For example, the first device 502 is described to operate the location unit 520, although it is understood that the second device 506 can also operate the location unit 520.

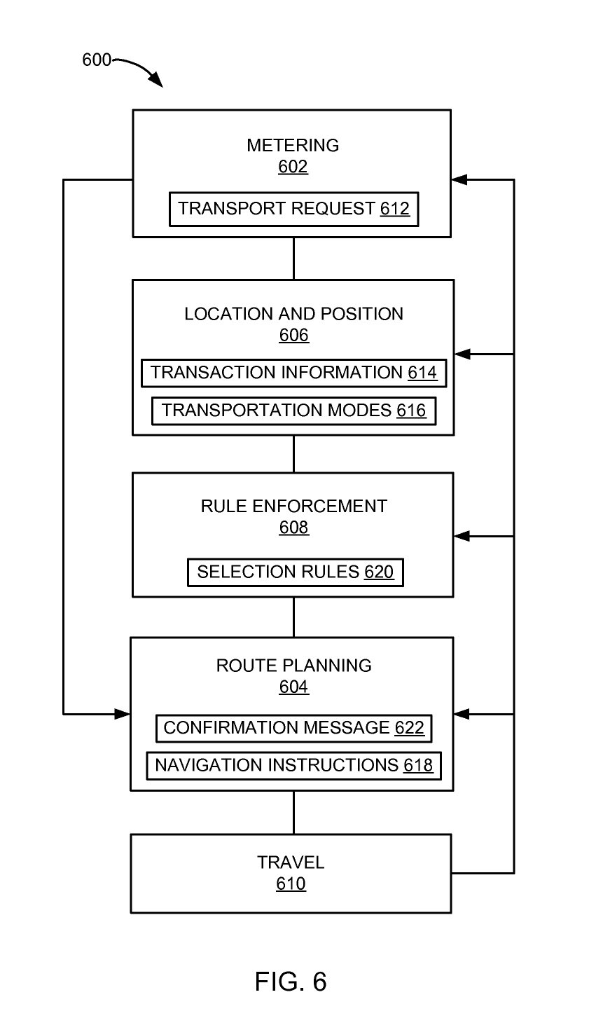

Referring now to FIG. 6, therein is shown a navigation system 600 with a transportation dispatch processing mechanism in a third embodiment of the present invention. The navigation system 600 can preferably include a metering module 602, a route planning module 604, a location and position module 606, a rule enforcement module 608, and a travel module 610. The metering module 602, the route planning module 604, the location and position module 606, the rule enforcement module 608, or the travel module 610 can be coupled to one another in any combination.

A transport request 612, including a delivery request or request for transportation, can be sent for the transport entity 208 of FIG. 2 and received by the metering module 602. The transport request 612 can be used to initiate a transaction to move the transport entity 208 to the destination point 210 of FIG. 2.

The transport request 612 can include information uniquely identifying the transport entity 208, the destination point 210, or the transfer point 206 of FIG. 2 for the transport entity 208. The starting location for the transport entity 208 can be either a pre-determined pick-up location or a present location of the transport entity 208.

The metering module 602 can preferably store the transport request 612 in the location and position module 606, a depository for transaction information 614. The metering module 602 can also send the transport request 612 to the route planning module 604.

A portion of the transaction information 614 in the location and position module 606 can be used to temporarily or permanently store the transportation providers 204 of FIG. 2, the transport entity 208, locations, preferences, geographic topologies, destinations, schedules, user defined data, or combinations thereof.

The transaction information 614 includes positional locations of the transportation providers 204 around a multi-dimensional region enclosing the transport entity 208, the transfer point 206, the destination point 210, and transportation modes 616. The multi-dimensional region is defined as a geographical region that is three dimensional. The transportation modes 616 are categories or types of mobile transportation apparatus. The transportation modes 616, for example, can include a car, a bus, a train, an aircraft, a subway, a motorcycle, a helicopter, a water vessel, or any method of transportation resulting in movement of goods, material, or personnel.

The metering module 602 can be implemented with the navigation system 500 of FIG. 5. For example, the metering module 602 can be implemented with the first user interface 518 of FIG. 5. the first communication unit 516 of FIG. 5, the first control unit 512 of FIG. 5, the first control interface 522 of FIG. 5, the location unit 520 of FIG. 5, the first storage unit 514 of FIG. 5, the communication path 504 of FIG. 5, the second communication unit 536 of FIG. 5, the second user interface 538 of FIG. 5, the second control unit 534 of FIG. 5, the second controller interface 544 of FIG. 5, the second storage unit 546 of FIG. 5, or a combination thereof.

The first control unit 512 or the second control unit 534 can process the transport request 612. The route planning module 604 receives the transport request 612 from the metering module 602 and uses or receives selection rules 620 provided by the rule enforcement module 608 to generate navigation instructions 618.

The selection rules 620 consists of information provided to the route planning module 604 to determine, constrain, or re-evaluate a preferred transportation solution. The selection rules 620, for example, can include operating hours and days of each of the transportation providers 204 or geographical terrain, traffic conditions, weather condition warnings, or travel advisories along possible travel routes under evaluation by the route planning module 604.

The navigation instructions 618 in the route planning module 604 can provide travel information needed to travel from one geographical location to another geographical location. The travel information can include information such as the designated geographical route 310 of FIG. 3, the relative geographical route 214 of FIG. 2, geographical reference points, estimate time of arrival, specific details related to the journey, or combinations thereof.

The route planning module 604 can preferably request for an acknowledgment from the transportation providers 204 and the transport entity 208 for a commitment, such as consensus of approval or acceptance, before the navigation instructions 618 are sent to the travel module 610. A confirmation message 622 can be detected by the route planning module 604 to indicate the commitment of the transportation providers 204 and of the transport entity 208. The confirmation message 622 can be used to indicate the commitment of both the transportation providers 204 and the transport entity 208.

The navigation instructions 618 are sent to the travel module 610 to provide for travelling, movement, or transportation of the transportation providers 204 and the transport entity 208. The route planning module 604 can be implemented with the navigation system 500 of FIG. 5.

For example, the route planning module 604 can be implemented with the first user interface 518 of FIG. 5. the first communication unit 516 of FIG. 5, the first control unit 512 of FIG. 5, the first control interface 522 of FIG. 5, the first storage unit 514 of FIG. 5, the communication path 504 of FIG. 5, the second communication unit 536 of FIG. 5, the second user interface 538 of FIG. 5, the second control unit 534 of FIG. 5, the second controller interface 544 of FIG. 5, the second storage unit 546 of FIG. 5, or a combination thereof.

The selection rules 620 of the rule enforcement module 608 can be used to analyze or select a solution based on the best delivery, the best partial delivery, the combinational transport, or the multiple delivery solution. The selection rules 620 of the rule enforcement module 608 can select the best delivery solution and provide the route planning module 604 with sufficient information to generate the navigation instructions 618.

The rule enforcement module 608 analyzes and determines the selection rules 620 using information that includes the transaction information 614 or the transportation modes 616 stored in the location and position module 606. The selection rules 620 can be used to select one or more of the transportation modes 616 best suited for the route planning module 604.

The rule enforcement module 608 can be implemented with the navigation system 500 of FIG. 5. For example, the rule enforcement module 608 can be implemented with the first user interface 518 of FIG. 5. the first communication unit 516 of FIG. 5, the first control unit 512 of FIG. 5, the first control interface 522 of FIG. 5, the first storage unit 514 of FIG. 5, the communication path 504 of FIG. 5, the second communication unit 536 of FIG. 5, the second user interface 538 of FIG. 5, the second control unit 534 of FIG. 5, the second controller interface 544 of FIG. 5, the second storage unit 546 of FIG. 5, or a combination thereof.

The location and position module 606 can be implemented with the navigation system 500 of FIG. 5. For example, the location and position module 606 can be implemented with the first user interface 518 of FIG. 5. the first communication unit 516 of FIG. 5, the first control unit 512 of FIG. 5, the first control interface 522 of FIG. 5, the location unit 520 of FIG. 5, the first storage unit 514 of FIG. 5, the communication path 504 of FIG. 5, the second communication unit 536 of FIG. 5, the second user interface 538 of FIG. 5, the second control unit 534 of FIG. 5, the second storage unit 546 of FIG. 5, or a combination thereof.

In an example, updated information from the metering module 602 could be stored in the location and position module 606. The updated information can include another request from another of the transport entity 312 of FIG. 3 to another of the destination point 308 of FIG. 3. The rule enforcement module 608 can access the information in the location and position module 606, analyze, or modify the selection rules 620 for the route planning module 604. The route planning module 604 can update the navigation instructions 618 to transport the transport entity 312 along a route that partially coincides with a route of the transport entity 208.

In another example, the selection rules 620 could be modified to by the rule enforcement module 608 to use constraints such as time-of-arrival, a minimum distance between the transport entity 208 and the destination point 210, costs of the transportation providers 204, locations of another transport entity, a quality of service metric, or any combination thereof.

In yet another example, the selection rules 620 could be modified by the rule enforcement module 608 to include the use one of the transportation providers 204 having one of the transportation modes 616 travel a portion of a delivery route to deliver the transport entity 208 to an intermediate transfer point similar to the transfer point 306 of FIG. 3 and another of the transportation providers 204 having a different one of the transportation modes 616 identified to deliver the transport entity 208 from the intermediate transfer point to the destination point 308.

A lack of the commitment from the transportation providers 204 to the route planning module 604 can result in the rule enforcement module 608 removing the transportation providers 204 from the information in the location and position module 606 and generation of new navigation instructions.

A lack of the commitment from the transport entity 208 to the route planning module 604 within a pre-defined elapsed time can result in the route planning module 604 re-evaluate and re-generate the new navigation instructions at a later time.

A cancellation of the transport request 612 can preferably result in termination or removal of the transport request 612 and a re-initialization of operations associated with the transport entity 208 within the route planning module 604, the metering module 602, the location and position module 606, and the rule enforcement module 608 by the travel module 610. The transport entity 208 arriving at the destination point 210 can also generate the cancellation.

The metering module 602 can access transport information from the location and position module 606 including the transaction information 614 or the transportation modes 616. The metering module 602 use the transport information to periodically monitor and query the geographic locations of the transportation providers 204 or the transport entity 208 associated with the transport request 612.

The metering module 602 can monitor the transportation providers 204 and another of the transport entity 208 located around a spherical perimeter region of the transport entity 208. The another of the transport entity 208 can have a different transport request similar to the transport request 612.

Rapid location changes or lack of a location change can be detected by the metering module 602 around the spherical perimeter region of the delivery route. The rapid location changes can result in the metering module 602 updating the information including the transaction information 614 or the transportation modes 616 stored in the location and position module 606.

The metering module 602 can periodically query the geographic locations at a pre-selected sampling rate, such as in seconds, minutes, or a combination thereof. The location changes can result in the metering module 602 generating a status interrupt.

The status interrupt can be sent to the route planning module 604 and the rule enforcement module 608 to initiate a re-evaluation of the information in the location and position module 606 to generate updates such as changes in the selection rules 620 or to the navigation instructions 618.

The travel module 610 presents the navigation instructions 618 to the transportation providers 204 or the transport entity 208 to execute the movement of the transport entity 208. An example of the travel module 610 presentation of the navigation instructions 618 can be seen in the screen on the display interface 202 as shown in FIG. 2 or FIG. 3.

The travel module 610 can be implemented with the navigation system 500 of FIG. 5. For example, the travel module 610 can be implemented with the first user interface 518 of FIG. 5, the first communication unit 516 of FIG. 5, the first control unit 512 of FIG. 5, the first control interface 522 of FIG. 5, the location unit 520 of FIG. 5, the first storage unit 514 of FIG. 5, the communication path 504 of FIG. 5, the second communication unit 536 of FIG. 5, the second user interface 538 of FIG. 5, the second control unit 534 of FIG. 5, the second controller interface 544 of FIG. 5, the second storage unit 546 of FIG. 5, or a combination thereof.

The metering module 602, the rule enforcement module 608, and the location and position module 606 incorporated into a typical or traditional route planning module enables the new transient location position service (T-LPS) usage module. The metering module 602 measures time sensitive location information and tracks user location over time.

The time sensitive location information will be registered into the location and position module 606. The metering module 602 can query the time sensitive location information registered in the location and position module 606. The rule enforcement module 608 implements the mechanisms or the selection rules 620 using pre-defined rules which will be used by the route planning module 604 or a normal rout planning module.

The navigation system 600 can be partitioned between the first device 502 of FIG. 5 and the second device 506 of FIG. 5. For example, the navigation system 600 can be partition into the functional units of the first device 502, the second device 506, or a combination thereof. The navigation system 600 can also be implemented as additional functional units in the first device 502, the second device 506, or a combination thereof.

It has been discovered that the metering module 602, the route planning module 604, the location and position module 606, the rule enforcement module 608, and the travel module 610 of the navigation system 600 provide significant value-added services based on transient (time or location) constraints for location position service (LPS).

It has been unexpectedly determined that the navigation system 600 uses dynamic time-sensitive, or location constraint information to plan the routes by locating other similar users.

It has been unexpectedly found that the navigation system 600 uses time constraint or location sensitive information to provide real time routing services by pre-defined rules.

It has been unexpectedly observed that the navigation system 600 provides time constraint routing serves based on transient location information. It has been unexpectedly recognized that a combination of the metering module 602, the rule enforcement module 608, and the route planning module 604 can analyze, select a solution, detect rapid location change, detect lack of location change, or removal of a transportation request.

It has been unexpectedly ascertained that the location and position module 606 can be used to temporarily or permanently store information such as the transportation providers 204, the transport entity 208, locations, preferences, destinations, schedules, user defined data, or combinations thereof.

The physical transformation of identifiers for the transportation providers 204, identifiers for the transport entity 208, locations, preferences, destinations, schedules, user defined data results in movement in the physical world, such as people using the first device 502, the second device 506, or vehicles, based on the operation of the navigation system 600 with shared transportation. As the movement in the physical world occurs, the movement itself creates additional information that is converted back to the identifiers for the transportation providers 204, identifiers for the transport entity 208, locations, preferences, destinations, schedules, user defined data for the continued operation of the navigation system 600 and to continue the movement in the physical world.

Thus, it has been discovered that the navigation system 600 and the first device 502 or the second device 506 of the present invention furnishes important and heretofore unknown and unavailable solutions, capabilities, and functional aspects for navigation with shared transportation.

The navigation system 600 describes the module functions or order as an example. The modules can be partitioned differently. Each of the modules can operate individually and independently of the other modules. For example, the location and position module 606 and the rule enforcement module 608 can be integrated and combined with the route planning module 604 to form a single module.

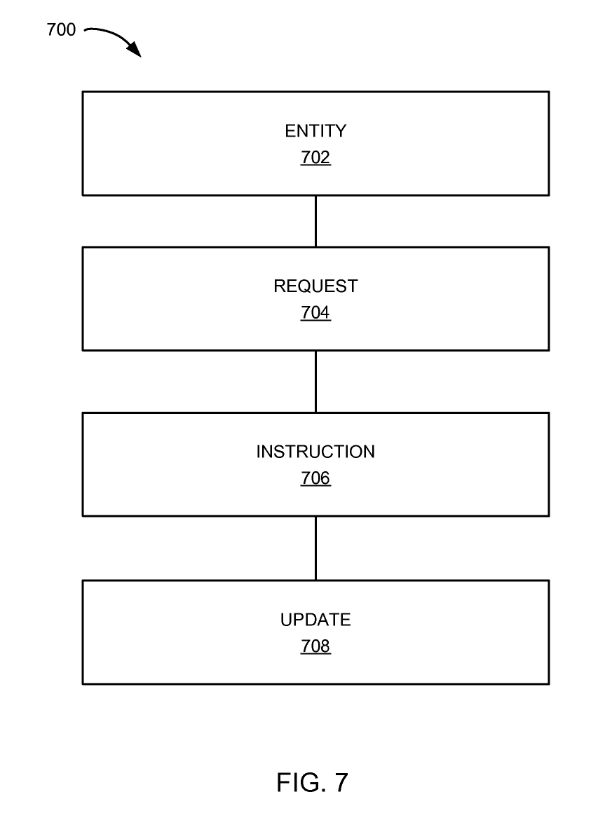

Referring now to FIG. 7, therein is shown a flow chart of a method 700 of operation of a navigation system in a further embodiment of the present invention. The method 700 includes: receiving a transport request for transporting a transport entity in an entity block 702; identifying one or more transportation modes based on the transport request for locating a transportation provider in a request block 704; generating a navigation instruction based on the transport request and the transportation modes, the navigation instruction for displaying on a device and for transporting the transport entity in an instruction block 706; and updating the navigation instruction for transporting the transport entity with a further transportation provider in an update block 708.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
receiving a transport request for transporting a transport entity;
identifying one or more transportation modes based on the transport request for locating a transportation provider;
generating a navigation instruction based on the transport request and the transportation modes, the navigation instruction for displaying on a device and for transporting the transport entity; and
updating the navigation instruction for transporting the transport entity with a further transportation provider.

2. The method as claimed in claim 1 further comprising selecting one or more of the transportation modes.

3. The method as claimed in claim 1 further comprising receiving a further transport request for transporting a further transport entity.

4. The method as claimed in claim 1 further comprising generating a selection rule to generate the navigation instruction.

5. The method as claimed in claim 1 wherein generating the navigation instruction includes generating the navigation instruction for transporting the transport entity and the transportation provider.

6. A method of operation of a navigation system comprising:
receiving a transport request for transporting a transport entity;
identifying one or more transportation modes based on the transport request for locating a transportation provider;
generating a navigation instruction based on the transport request and the transportation modes, the navigation instruction for displaying on a device and for transporting the transport entity;
updating the navigation instruction for transporting the transport entity with a further transportation provider; and
receiving a further navigation instruction based on the updating of the navigation instruction for displaying on the device.

7. The method as claimed in claim 6 further comprising:
receiving a further transport request for transporting a further transport entity; and
wherein:
updating the navigation instruction includes updating the navigation instruction for transporting the further transport entity.

8. The method as claimed in claim 6 further comprising receiving a further transport request for transporting the transport entity.

9. The method as claimed in claim 6 further comprising generating a selection rule for updating the navigation instruction to the further transportation provider.

10. The method as claimed in claim 6 wherein generating the navigation instruction includes generating the navigation instruction for transporting the transport entity or the transportation provider.

11. A navigation system comprising:
a user interface for receiving a transport request for transporting a transport entity;
a location unit, coupled to the user interface, for identifying one or more transportation modes based on the transport request for locating a transportation provider;
a route planning module, coupled to the location unit, for generating a navigation instruction based on the transport request and the transportation modes, the navigation instruction for displaying on a device and for transporting the transport entity; and
a control unit, coupled to the route planning module, for updating the navigation instruction for transporting the transport entity with a further transportation provider.

12. The system as claimed in claim 11 further comprising a rule enforcement module, coupled to the control unit, for selecting one or more of the transportation modes.

13. The system as claimed in claim 11 further comprising a communication unit, coupled to the control unit, for receiving a further transport request for transporting a further transport entity.

14. The system as claimed in claim 11 further comprising a rule enforcement module, coupled to the route planning module, for generating a selection rule to generate the navigation instruction.

15. The system as claimed in claim 11 wherein the route planning module is for generating the navigation instruction for the transport entity and the transportation provider.

16. The system as claimed in claim 11 wherein the user interface is for receiving further navigation instruction based on the updating of the navigation instruction for displaying on the device.

17. The system as claimed in claim 16 further comprising:
a communication unit, coupled to the user interface, for receiving a further transport request for transporting a further transport entity; and
wherein:
the control unit for updating the navigation instruction for transporting the further transport entity.

18. The system as claimed in claim 16 further comprising a communication unit, coupled to the user interface, for receiving a further transport request for transporting the transport entity.

19. The system as claimed in claim 16 further comprising a rule enforcement module, coupled to the location unit, for generating a selection rule for updating the navigation instruction to the further transportation provider.

20. The system as claimed in claim 16 wherein the route planning module is for generating the navigation instruction for the transport entity or the transportation provider.
